(19) United States
(12) Patent Application Publication
(10) Pub. No.: US 2008/0172890 A1
(43) Pub. Date: Jul. 24, 2008

(54) Reciprocating double sided saw blade with double leg supports

(75) Inventor: Thomas H. Shetterly, Walnut Creek, CA (US)

Correspondence Address: LEE W. TOWER, 19 SADDLE ROAD, RANCHO PALOS VERDES, CA, 90275, US

(73) Assignee: Thomas H. Shetterly, Walnut Creek, CA (US)

(21) Appl. No.: 11/654,932

(22) Filed: Jan. 18, 2007

(51) Int. Cl. B23D 49/00

(52) U.S. Cl. 30/355

(57) ABSTRACT

A double-sided saw blade has a first longitudinal cutting edge, a second longitudinal cutting edge opposed to the first cutting edge, and a “U” shaped tang end for enabling selective attachment of the saw blade with a saw. The “U” shaped tang end has a hole located generally in the middle of the blade's width and near to the “U” shaped tang end for attachment to a peg in the saw. A first support leg is arranged on a side of the “U” shaped tang end and extends from the saw blade, and a second support leg arranged on an opposite side of the “U” shaped tang end. A curved end between the first longitudinal cutting edge and the second longitudinal cutting edge has teeth and the first longitudinal cutting edge curves up to join the second longitudinal cutting edge.

### BACKGROUND OF THE INVENTION

1. Field of the Invention

This invention relates to reciprocating saw blades, and also to jigsaw, sabersaw, and self-starting saw blades.

2. Background Information

A saw such as a reciprocal saw, jigsaw, sabersaw, and self-starting saw may be used with a variety of blades, depending upon the material being cut and the type of coarse or fine cut desired. Each time another type of blade is required then a woodworker must remove the blade from the saw and then reattach a different blade to the saw.

Generally reciprocating saw blades are single sided. During a cutting operation, it is frequently required to remove the single sided blade from the saw and then install the blade in reverse in the saw so that the saw can be used to cut in a different direction. This requires the worker to slow down while removing the blade, reversing the blade, and then reattaching the blade to the saw.

U.S. Patent Application Publication 2003/0192419, published Oct. 16, 2003 describes a double-sided saw blade that avoids having to reverse the blade in the saw. The publication also describes that the teeth on the two opposite sides of the saw blade can be such that one side is optimal for one type of material or fineness of cut, while the other side is optimal for another type of material or another fineness of cut.

Typically a reciprocating saw blade has on the installation end of the blade a hole that is attached to a peg in the saw and a single support leg that prevents the blade from pivoting on the peg. The single support leg is typically on the side opposite to the blade on a single side reciprocating saw blade.

A limitation of the designs disclosed in both U.S. Patent Application Publication 2003/0192419 published by Conti and U.S. Design Pat. D427,865 issued Jul. 11, 2000 to Mills is that each of these designs have a double sided blade with only one support leg. A double sided blade will have too much play and be unstable if it has only a single support leg. The forces on the normal one sided blade of the saw can be adequately supported by a single support leg, but when the blade on the other side of a double sided blade is used, the single support leg is not adequate. The double sided blade will be unstable and will quickly become unusable.

U.S. Design Pat. D448,634, issued Oct. 2, 2001 to Hickman does show a design for a double-edged saw blade for reciprocating saws that has two support legs. However, the design does not have a separate hole that fits over the peg in the standard manner. Thus the legs are not as stable as desired. Also the blade design has a blunt end that can not be used for starting a cut in the middle of a piece of wood or other material without first drilling a hole.

Accordingly, there is a need in the art for a reciprocating saw blade that overcomes the limitations of the prior art.

### SUMMARY OF THE INVENTION

A double-sided saw blade has a first longitudinal cutting edge, a second longitudinal cutting edge opposed to the first cutting edge, and a “U” shaped tang end for enabling selective attachment of the saw blade with a saw. The “U” shaped tang end has a hole located generally in the middle of the blade's width and near to the “U” shaped tang end for attachment to a peg in the saw. A first support leg is arranged on a side of the “U” shaped tang end and extends from the saw blade, and a second support leg arranged on an opposite side of the “U” shaped tang end. A curved end between the first longitudinal cutting edge and the second longitudinal cutting edge has teeth and the first longitudinal cutting edge curves up to join the second longitudinal cutting edge.

Other attendant features of this invention will be more readily appreciated as the same becomes better understood by reference to the following detailed descriptions and considered in connection with the accompanying drawings in which like reference symbols designate like parts throughout the figures.

### BRIEF DESCRIPTION OF THE DRAWINGS

FIGS. 1 and 2 show a prior art double sided saw blade.

FIG. 3 is a perspective view of a reciprocating saw blade showing a double sided saw blade with double leg supports in accordance with the present invention.

FIG. 4 is a left side elevational view of the reciprocating saw blade in accordance with the present invention.

FIG. 5 is a right side elevational view of the reciprocating saw blade in accordance with the present invention.

FIG. 6 is a top view of the reciprocating saw blade in accordance with the present invention.

FIG. 7 is a bottom view of the reciprocating saw blade in accordance with the present invention.

FIG. 8 is a front elevational view of the reciprocating saw blade in accordance with the present invention.

FIG. 9 is a rear elevational view of the reciprocating saw blade in accordance with the present invention.

FIG. 10 is a Left side elevational view of the reciprocating saw blade with denser teeth on the top cutting edge than on the bottom cutting edge in accordance with the present invention.

### DETAILED DESCRIPTION OF THE PREFERRED EMBODIMENT

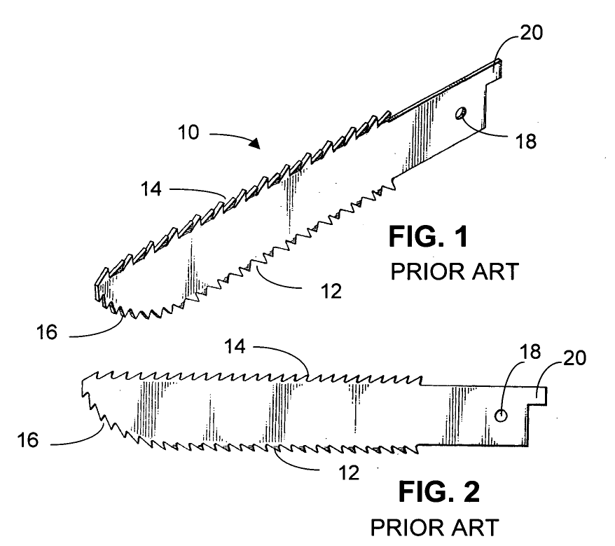

Referring now to the drawings, FIGS. 1 and 2 show a prior art blade. This blade is the subject of U.S. Design Pat. D427,865 issued Jul. 11, 2000 to Mills. The prior art saw blade 10 comprises an elongated, substantially flat body having a universal tang end, a double sides blades 12 and 14 and a curved end 16. The universal tang end has a hole 18 and a single tang 20. As described above this blade will be unstable, because it has only a single support leg.

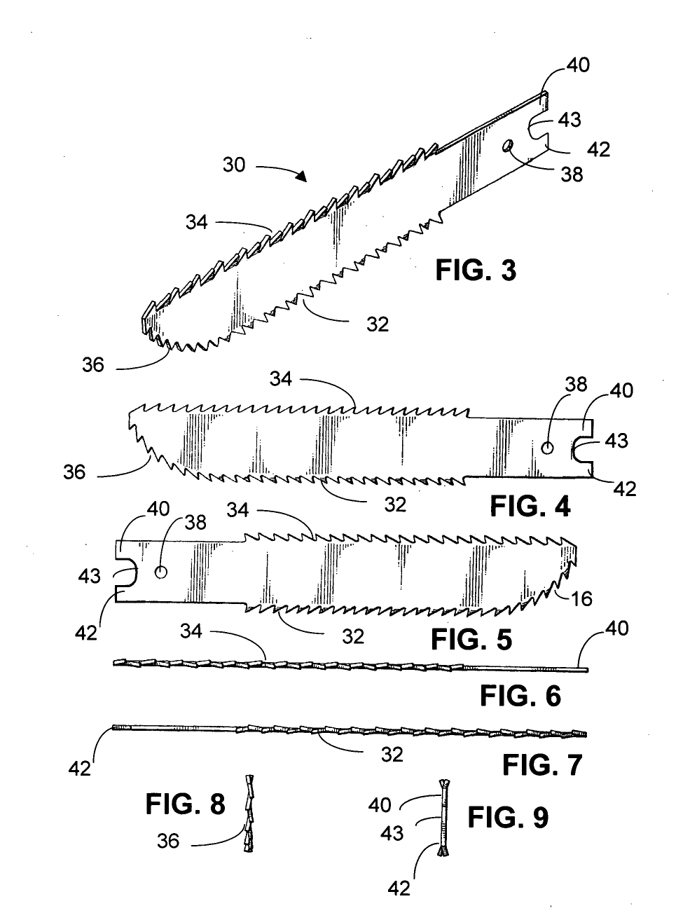

FIG. 3 shows a perspective view of the double-sided saw blade 30 according to the present invention. The blade is for use in a motor-driven reciprocating blade saw such as a jigsaw, sabersaw, and self-starting saw blades, or in, for example a “Sawzall” manufactured by the Milwaukee Electric Tool Corporation. These types of reciprocating saws have a reciprocating spindle driven by the motor to which the saw blade is removably attached.

The double-sided saw blade 30, as further shown in FIGS. 4-9 has an elongated, substantially flat body having a “U” shaped tang end 43, a curved end 36, a first longitudinal cutting edge 32 and a second longitudinal cutting edge 34.

The “U” shaped tang end 43 has a hole 38 placed generally in the middle of the blade's width and is separate but near to the “U” shaped tang end 43. The “U” shaped tang end 43 has two support legs 40 and 42 that extend from the blade and are arranged on opposite sides of the “U” shaped tang end 43. This arrangement provides support and stability no matter which cutting edge 32 or 34 is used. Without the double support legs 40 and 42, the blade is likely to deflect and become unusable. The support legs 40 and 42 prevent the blade from tilting in the saw when it is cutting in either direction. The “U” shaped tang end 43 minimizes stress on the support legs 40 and 42. A rectangular shaped tang end would have more stress and would not be as reliable, although such an end can be used.

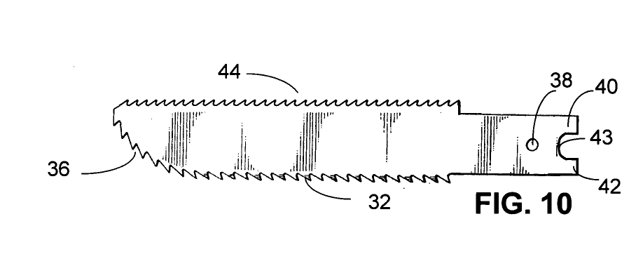

As shown in FIG. 4, the first and second cutting edges 32 and 34 have a plurality of cutting teeth. The cutting teeth on cutting edge 32 can be configured for rough cuts and the cutting edge on cutting edge 34 can be configured for smoother cuts. This is illustrated in FIG. 10, which shows a reciprocating saw blade with denser teeth on the top cutting edge than on the bottom cutting edge. For example cutting edge 32 could have 7 teeth per inch and cutting edge 34 could have 9 teeth per inch. The teeth may be of different heights, widths, and the teeth may be spaced apart by various distances.

The cutting edges can have bi-metal teeth. This allows the operator to cut wood, plastic or other materials and also cut through embedded nails or metal which may be hidden 1n the wood. Bi-metal teeth will also cut steel pipe, brackets, and other metallic items.

The double sided blade allows the operator to cut continuously back and forth without having to remove the blade from the cut in order to change directions. This has distinct advantages for use with a Sawzall blade. Moreover, when using the double sided blade in a jigsaw it has even more relevance, because one does not have to remove the saw from the cut in order to cut the opposite or some other direction. This is very important when cutting patterns.

The curved tip 36 allows one to start a cut without boring a hole first to do so. This is again very important for many applications including for a jigsaw. The curved tip 36 also allows for plunge cuts without kickback. If the operator rolls the curved tip of the blade into a cut, pre-drllling is unnecessary.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope of the present invention and additional fields in which the present invention would be of significant utility.

It is therefore intended by the appended claims to cover any and all such applications, modifications and embodiments within the scope of the present invention.

What is claimed is:

1. A saw blade comprising:
a first longitudinal cutting edge;
a second longitudinal cutting edge opposed to the first cutting edge;
a “U” shaped tang end for enabling selective attachment of the saw blade with a saw, the “U” shaped tang end comprising:
a hole located generally in the middle of the blade's width and near to the “U” shaped tang end for attachment to a peg in the saw;
a first support leg arranged on a side of the “U” shaped tang end and extending from the saw blade; and
a second support leg arranged on an opposite side of the “U” shaped tang end and extending from the saw blade.

2. The saw blade of claim 1 further comprising a curved end between the first longitudinal cutting edge and the second longitudinal cutting edge wherein:
the curved end has teeth; and
the first longitudinal cutting edge curves up to join the second longitudinal cutting edge.

3. The saw blade of claim 1 wherein each cutting edge is comprised of a plurality of cutting teeth, and wherein the cutting teeth on the first longitudinal cutting edge are arranged in one manner, and the cutting teeth on the second longitudinal cutting edge are arranged in another manner.

4. The reciprocating saw blade of claim 3 wherein the cutting teeth on the first longitudinal cutting edge are arranged for cutting a first material, and the cutting teeth on the second longitudinal cutting edge are arranged for cutting a second material.

5. The reciprocating saw blade of claim 3 wherein the cutting teeth on the first longitudinal cutting edge and the second longitudinal cutting edge are bi-metal.

6. A saw blade comprising:
a first longitudinal cutting edge;
a second longitudinal cutting edge opposed to the first cutting edge;
a “U” shaped tang end for enabling selective attachment of the saw blade with a saw, the “U” shaped tang end comprising:
a hole located generally in the middle of the blade's width and near to the “U” shaped tang end for attachment to a peg in the saw;
a first support leg arranged on a side of the “U” shaped tang end and extending from the saw blade; and
a second support leg arranged on an opposite side of the “U” shaped tang end and extending from the saw blade; and
a curved end between the first longitudinal cutting edge and the second longitudinal cutting edge wherein:
the curved end has teeth; and
the first longitudinal cutting edge curves up to join the second longitudinal cutting edge.

7. A saw blade comprising:
a first longitudinal cutting edge;
a second longitudinal cutting edge opposed to the first cutting edge;
a tang end for enabling selective attachment of the saw blade with a saw, the tang end comprising:
a hole located generally in the middle of the blade's width and near to the tang end for attachment to a peg in the saw;
a first support leg arranged on a side of the tang end and extending from the saw blade; and
a second support leg arranged on an opposite side of the tang end and extending from the saw blade; and
a curved end between the first longitudinal cutting edge and the second longitudinal cutting edge wherein:
the curved end has teeth; and
the first longitudinal cutting edge curves up to join the second longitudinal cutting edge.
